(19) United States
(12) Patent Application Publication
(10) Pub. No.: US 2007/0089766 A1
(43) Pub. Date: Apr. 26, 2007

(54) Mobile device for washing bulky articles

(76) Inventors: Nicholaos Dimitri Fanourgiakis, Foster City, CA (US); John Dimitri Fanourgiakis, Millbrae, CA (US)

Correspondence Address: SCHNECK & SCHNECK, P.O. BOX 2-E, SAN JOSE, CA, 95109-0005, US

(21) Appl. No.: 11/257,302

(22) Filed: Oct. 24, 2005

(51) Int. Cl. B08B 3/04; B08B 3/12; B08B 3/00

(52) U.S. Cl. 134/104.2; 134/172; 134/123; 134/184; 134/175; 134/198

(57) ABSTRACT

A device for washing bulky items including a trailer having a wash compartment. The floor of the wash compartment allows waste water to be collected and pumped from the interior of the compartment. Onboard generators provide power to a pump for collecting waste water and to a pressure washer that heats water and provides pressured wash liquid to hoses. These hoses may be used to provide heated, high pressure stream of washing liquid to items contained within the wash compartment.

### TECHNICAL FIELD

The present invention relates to devices for washing articles, and more specifically to devices for washing bulky articles.

### BACKGROUND

Bulky items used by commercial establishments, including plastic floor mats, shopping carts, outdoor tables and chairs, etc. require periodic washing. One common method of washing such items would simply be for the store to use a pressure washer to wash the items. However this has a number of drawbacks. First, the use of this equipment is noisy and messy, creating unpleasant noise that may create a negative impression for customers. Second, the use of a pressure washer outdoors creates an environmental disposal hazard. The dirty wash solution could run off into the storm drain system and pollute waterways. For this reason local ordinances in a number of cities do not allow the dumping of this waste water from commercial establishments into storm drains. A final drawback is that the pressure system would have to be stored at the commercial establishment, which takes up space for a tool that is used infrequently.

A number of prior systems have been designed to allow for washing specific items. For example, U.S. Pat. Nos. 3,444,867, 3,698,029, 4,807,319, 6,427,707 and U.S. Patent Application Publication No. 2003/0061674 all disclose mobile trailers for washing specific items, such as shopping carts or golf carts. In these systems, the trailer has ramps at the front and back of the trailer. The cart is rolled up the front ramp into an enclosed wash space where the cart is washed by a wash system. The cart is then rolled out the back of the trailer.

Because the front and back ends of the trailer are open, the different components used in the system (e.g., pumps, generators, tanks, etc.) must be either on the sides of the trailer or on the roof of the trailer. If the components are on the roof of the trailer, they are rather difficult to access. If the components are on the sides, they significantly reduce the size of the usable area in which items can be washed. In a number of such systems, the washing area is only about as wide as a shopping cart. In a number of such systems, placing components on the side of the trailer exposes these components to risk of damage as the trailer is transported or used. If components are located on the sides and then enclosed in a shell mounted on the trailer, these components are more difficult to access.

It is an object of the invention to provide a wash trailer that may be used to clean bulky items. It is a further object that this system collect waste water, so that it does not drain into storm drains. It is a further object that the trailer allow for washing a number of different items. It is a further object that the user have access from above the item during washing so that the user may wash the items.

### SUMMARY

The above objects have been achieved with a mobile trailer for washing bulky items. The trailer includes an open-top washing compartment having a metal screen floor through which liquid can drain. The trailer includes at least one set of wheels and a hitch at the back for towing the trailer. A front wall of the trailer may be lowered to act as a ramp to allows wheeled carts to be rolled into the washing compartment. At the back of the trailer is a compartment containing at least one generator and a pressure washer. This pressure washer heats and pressures the wash liquid, and provides this heated pressurized liquid to wash hoses in wash compartment of the trailer. A user may then use the wash liquid coming from a nozzle at the end of the hose to clean items in the wash compartment. The waste liquid would then drain through the floor and be collected and pumped from the wash compartment. The generator provides the power to the pressure washer, pump, and any other electrical devices on the trailer. Thus the trailer is essentially self contained. The user would only need to provide access to a water source sufficiently close such that it could be reached by the supply hose on the pressure washer.

This device could include a number of additional features, including a number of hose retainers within the washing compartment, the use of a sealant on the side and rear walls, lighting for the interior of the washing compartment or the exterior of the trailer, and vents in the rear compartment for venting the generator and the pressure washer.

### BRIEF DESCRIPTION OF THE DRAWINGS

FIG. 1 is a front perspective view of the interior compartment of a trailer including a washing system.

FIG. 2 is a rear perspective view of the interior of the rear compartment of the trailer shown in FIG. 1.

FIG. 3 is a side perspective view of the trailer of FIG. 1.

### DETAILED DESCRIPTION

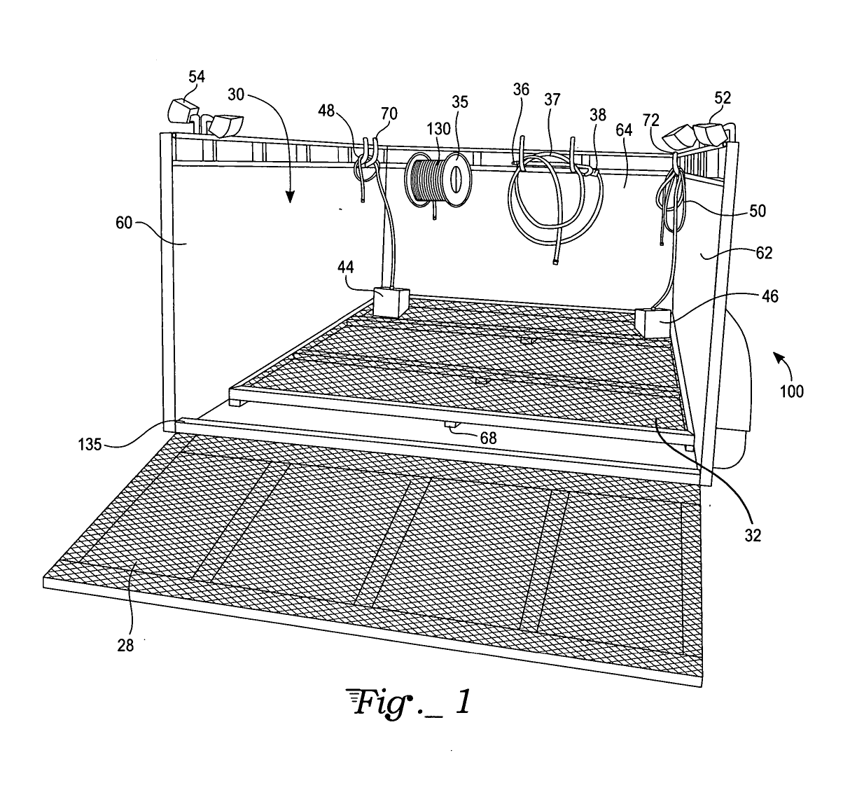

With reference to FIG. 1, the trailer 100 shown includes a first side wall 60, a second side wall 62 and a back wall 64. These walls with floor 32 define an open top wash compartment 30. Walls 60, 62 and 64 may be treated with a sealant to reduce noise and seal the wall. A bed liner sealant reduces noise and adds durability. One such sealant is spray on polyurethane. Spray on polyurethane is chemical resistant, is slip resistant so it may be used on floors, protects against mildew, rust and corrosion, will not crack or split in heat or cold (−15° F. to 300° F.), and may be sprayed on in safety colors if needed. This produce is adaptable to hot application, eliminating running and ensuring a quick dry time. Ramp 28 may be raised to act as a front wall during transport of the trailer. When the trailer has been parked at the location where it is to be used, ramp 28 may be unlatched and lowered. The ramp 28 is made of a steel, grating material that is somewhat bumpy in texture. When carts are rolled up the ramp into the washing compartment, the bumpy nature of the open grating serves to shake loose adherent debris on the cart, which would then fall through the grating and could later be swept up.

The floor 32 of the wash compartment is supported on legs 68 that raise the floor 32 about an inch to an inch and a half from the bed of the trailer. Bump 135 at the front of the trailer retains the waste water. This bump may be rounded and elongated such that it is easier to roll a shopping cart from the ramp 28 onto flooring 32. This provides a space for the waste water to flow. Because the water flows to this space, it is able to flow off of the items being washed, which allows the washed items to drip dry. The dirty water flows below floor 32 to pumps 44 and 46. The trailer may be canted to ensure that the pumps 44, 46 are at the lowest point, such that water collects at the pumps. Pumps 44, 46 pump the collected water into hoses 48, 50. When not in use, these hoses may be retained on retaining hooks 70, 72.

At the back wall 64 is mounted a spool 35 holding a hose 130. This hose allows connection to an external water source. Hung on the back wall is hose 37 having a wash gun 36 attached by a nozzle connection 38.

During washing, a wheeled device is rolled up ramp 28 and into wash compartment 30. Alternatively, the items can be simply carried into the wash compartment 30 or dropped into compartment 30 from above. Wash hose 37 is unhooked for a sufficient length such that a user can direct a spray of heated and pressured wash liquid at the item being washed. The wash gun 36 allows targeted spraying of the wash liquid onto the items being washed. The waste water dripping from the washed items then flows through the grating of floor 32 to a subfloor area and flows to pumps 44, 46. The pumps removes the waste water into waste water hoses 48, 50. These hoses may be placed into receiving tanks, for example one on a truck that tows trailer 100. This waste water may then be disposed of into a water treatment facility or recycled if possible.

Lights 52, 54 provide lighting to the wash compartment and the exterior of the trailer. This may allow use of the trailer at night.

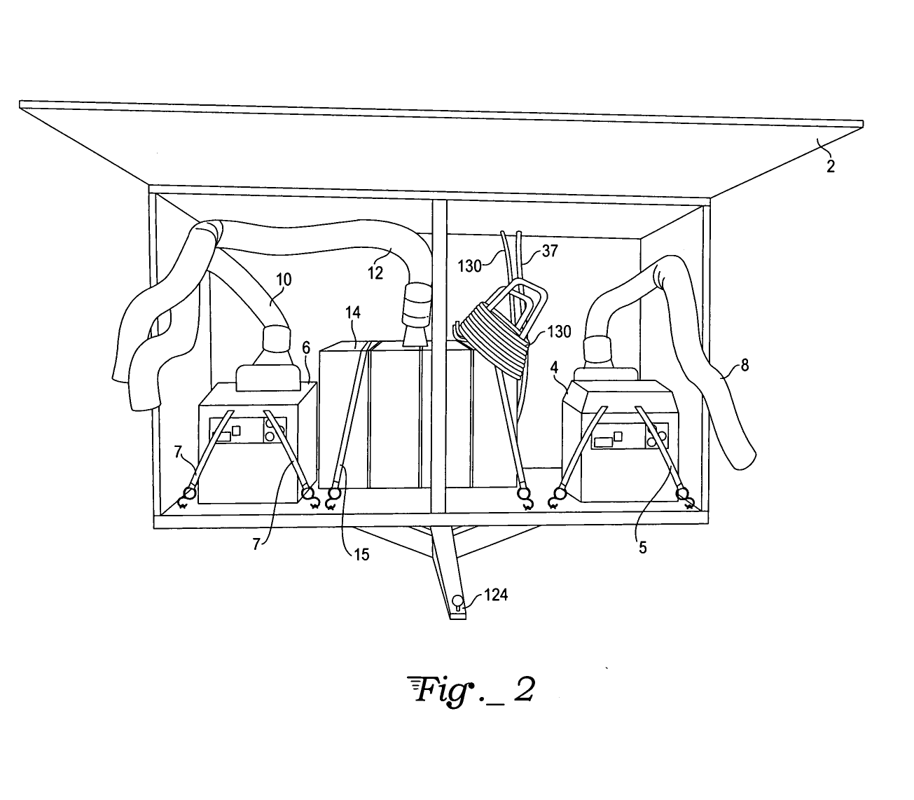

Behind back wall 64 is a back compartment shown in FIG. 2. This compartment has a back compartment door 2, attached by hinges. It is shown raised but would be lowered during transport to protect the devices in this rear compartment. Generators 4, 6 are secured within the rear compartment by tie downs 5, 7. The generators generate electrical power and provide electricity to the lights, pumps, and the pressure washer. Ducts 8, 10 vent the exhaust from the generators 4, 6.

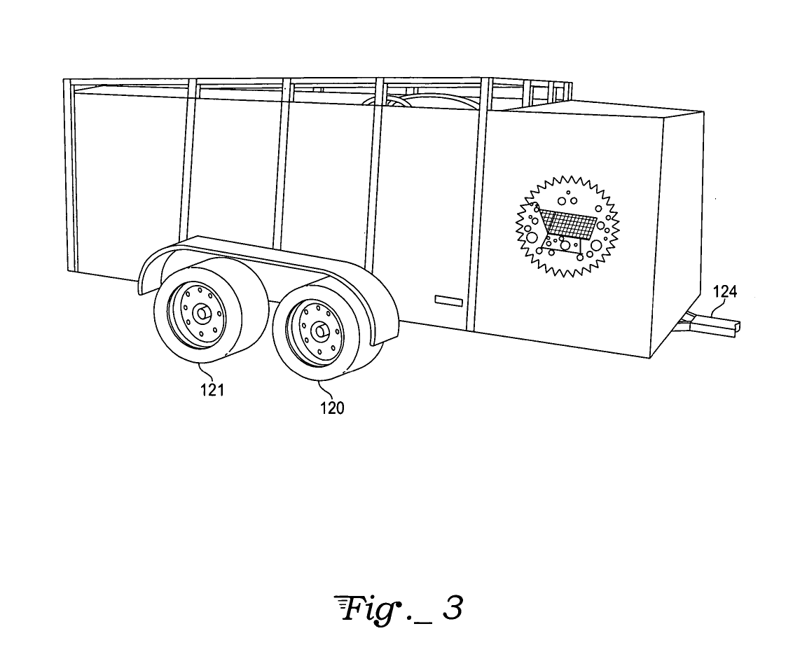

The pressure washer 14 is also in the rear compartment. In one embodiment, the pressure washer 14 includes an onboard or external tank to hold a concentrated wash solution. The pressure washer then heats and pressurizes the wash liquid and supplies the liquid to hose 37, which extends into the wash compartment shown in FIG. 3. A water supply hose 130 on the pressure washer allows connection to an external source of water. Although an external source of water is required, electricity is supplied with an onboard system, so the trailer is otherwise self supplied for its requirements during washing. The pressure washer is secured into the rear compartment by tie downs 15. The exhaust from the power washer is vented through duct 12. The ducts are shown simply extending to the edge of the trailer. In an alternative configuration, the ducts could be vented through a wall of the back compartment of the trailer.

Extending from the bottom of the trailer is hitch 124. The hitch may be set onto the ground to allow the trailer to be free standing. Adjusting the height of the hitch 124 allows the trailer to be positioned such that the flooring is canted slightly, so that the pumps are downhill from the ramp into the trailer.

A number of the elements, including the generators, pressure washer, lights and pumps may be a single device, or two or more devices that act in tandem.

With reference to FIG. 3, the trailer is shown from the sides. The wheels 120, 121 are a mounted on a double axle, to provide the trailer with stability. Alternatively, a single axle trailer could be used. The hitch allows the trailer to be towed and positioned on the ground.

A number of the advantages of the described system are self-apparent. This trailer may be transported to the location where it is to be used, used for the period necessary, and then transported to the location of the next customer. The used cleaning solution is collected, stored on the trailer, and may be disposed of by recycling the solution if possible or draining the solution into a water treatment system, rather than into a storm drain. The ramp allows simplified loading and unloading of carts or other wheeled devices. In addition, material may be placed into the cart from above and the washing may occur from above. If for example, a supermarket wanted to wash a plurality of plastic pallets in the trailer, the trailer could be moved into a loading dock, the articles dropped into the trailer from above, and the items washed from above. The articles could be unloaded from the ramp, or from the open top of the wash compartment.

The rear compartment is very simple to access, yet provides protection for components including the pump, generator, and pressure washer. This rear compartment is easily accessed, allowing the components to be replaced if damaged or if upgrades are required. This area also provides a storage space for any additional items required for the sanitizing process.

What is claimed is:

1. A mobile device for washing bulky articles comprising:
a trailer having at least two wheels;
a trailer hitch at a back end of said trailer;
a trailer bed mounted on said trailer, said bed having a back wall, a first side wall and a second side wall defining an open top washing compartment;
a metal screen floor in said trailer bed;
a hinged front trailer wall configured such that in a lowered position said wall functions as a ramp, and in a raised position said front wall fits against ends of the first side wall and the second side wall to enclose an interior trailer space;
at least one pump positioned to collect water draining from said floor during washing, said at least one pump connected to a waste water hose;
a back compartment in said trailer behind said back wall;
at least one generator contained within said back compartment;
at least one pressure washer in said back compartment;
a water supply hose mounted on said pressure washer allowing connection to an external water source, said water hose providing a water source to said at least one pressure washer; and
at least one power wash hose on said trailer in fluid communication with said at least one pressure washer such that a cleaning liquid from said pressure washer may be directed onto articles in the interior of said trailer, wherein said generator provides electrical power to power requiring devices on the trailer including said power washer and said pump.

2. The device of claim 1, wherein said generator and said pressure washer have exhaust vents configured to vent exhaust from said back compartment.

3. The device of claim 1, wherein said trailer includes a plurality of means for retaining hoses within said interior trailer space.

4. The device of claim 4, wherein said back wall, said first side wall and said second side wall are treated with a noise reducing sealant.

5. The device of claim 1, further including lighting mounted on an upper railing on said trailer.

6. The device of claim 5, wherein said lighting includes lighting configured to light said open top washing compartment.

7. The device of claim 5, wherein said lighting includes lighting configured to provide light to an exterior of the trailer.

8. The device of claim 1, wherein said hitch and said four wheels allow the trailer to be free standing.

9. The device of claim 1, wherein said a hinged front trailer wall is configured such that in a lowered position said wall functions as a ramp and wherein said front wall is made of an uneven open metal screen.

10. The device of claim 1 wherein said back compartment includes a door which may be raised and wherein said at least one generator and at least one pressure washer are vented to outside said back compartment.
